(19) United States
(12) Patent Application Publication
(10) Pub. No.: US 2014/0002577 A1
(43) Pub. Date: Jan. 2, 2014

(54) Videoconferencing Technique

(71) Applicants: Cristian A. Bolle, Bridgewater, NJ (US); David A. Duque, Hillsborough, NJ (US); Roland Ryf, Aberdeen, NJ (US)

(72) Inventors: Cristian A. Bolle, Bridgewater, NJ (US); David A. Duque, Hillsborough, NJ (US); Roland Ryf, Aberdeen, NJ (US)

(21) Appl. No.: 13/537,295

(22) Filed: Jun. 29, 2012

(51) Int. Cl. H04N 7/15

(52) U.S. Cl. CPC H04N 7/15
USPC 348/14.02

(57) ABSTRACT

An videoconferencing technique comprises a display substrate occupying less than an entirety of a viewing area; an actuator configured to move the display substrate over the viewing area; a camera having a field of view at least partially overlapping the viewing area and configured to capture a camera image through the viewing area. A transmitter is configured to transmit, through a transmission medium, a signal comprising videoconferencing data; a receiver is configured to receive the signal from the transmission medium and at least a portion of the transmission medium comprises a free space transmission region.

### TECHNICAL FIELD

The disclosure is directed, in general, to a videoconferencing technique.

### BACKGROUND

This section introduces aspects that may be helpful in facilitating a better understanding of the disclosure. Accordingly, the statements of this section are to be read in this light and are not to be understood as admissions about what is in the prior art or what is not in the prior art.

Communications via computer networks frequently involve far more than transmitting text. Computer networks, such as the Internet, can also be used for audio communications and visual communications. Still images and video are examples of visual data that may be transmitted over such networks.

One or more cameras may be coupled to a personal computer (PC) to provide visual communication. The camera or cameras can then be used to transmit real-time visual information, such as video, over a computer network. Dual transmission can be used to allow audio transmission with the video information. Whether in one-to-one communication sessions or through videoconferencing with multiple participants, participants can communicate via audio and video in real time over a computer network (i.e., voice-video communications). Typically the visual images transmitted during voice-video communication sessions depend on the placement of the camera or cameras.

### SUMMARY

In one aspect there is provided a display substrate and a receiver jointly movable with the display substrate relative to a transmitter. The display substrate has a plurality of light sources thereon. The receiver is configured to receive a signal containing information from the transmitter through a transmission medium. The transmission medium comprises free space and the information is usable for selectively activating the light sources to generate an image.

### BRIEF DESCRIPTION OF THE DRAWINGS

Reference is now made to the following descriptions taken in conjunction with the accompanying drawings, in which:

FIG. 1 is a schematic block diagram of an embodiment of a videoconferencing infrastructure within which a videoconferencing terminal constructed according to the principles of the disclosure may operate;

FIG. 2A and FIG. 2B are exemplary schematic representations of an embodiment of a videoconferencing terminal, in which the principles of the disclosure may be implemented;

FIG. 3 is an exemplary schematic representation of an exploded view of certain elements of an embodiment of a videoconferencing terminal according to the principles of the disclosure;

FIG. 4 is an exemplary schematic representation of another exploded view of certain elements of the videoconferencing terminal of FIG. 3 within which the principles of the disclosure are implemented;

FIG. 5 is an exemplary schematic representation of an exploded view of certain elements of another embodiment of a videoconferencing terminal according to the principles of the disclosure;

FIG. 6 is an exemplary representation of an alternative embodiment of a display substrate according to the principles of the disclosure;

FIG. 7 is an exemplary representation of certain elements of the videoconferencing terminal according to another embodiment of the disclosure; and

FIG. 8 is an exemplary representation of an alternative embodiment of the videoconferencing terminal showing a bidirectional coupling in a videoconferencing terminal according to the principles of the disclosure.

### DETAILED DESCRIPTION

In videoconferencing applications, videoconferencing terminals are used for example between two users that wish to establish videoconferencing, each user typically using a respective videoconferencing terminal (or apparatus).

Herein, videoconferencing data may comprise visual communication data, audio communication, or a combination thereof.

In a videoconferencing terminal, establishing eye contact between the participants greatly enhances the feeling of intimacy. Unfortunately, the display and camera in many conventional videoconferencing terminals are not aligned. The resulting parallax prevents eye contact from being established between participants of the videoconference.

US Patent Publication 2011/0149012 describes a videoconferencing terminal with a persistence of vision display and a method of operation thereof to maintain eye contact, which is incorporated herein by reference in its entirety.

Disclosed herein are embodiments of a terminal for videoconferencing, having a “persistence of vision” display that is used in combination with a camera located behind the display to simultaneously show an image of a remote object such as a remote videoconference participant and capture an image of a local object such as a local videoconference participant.

The videoconferencing terminals can display an image by employing an array of electronic light sources (e.g., red, green and blue light-emitting diodes (LEDs)) spun at a speed high enough such that the human eye cannot follow the motion and will see a continuous image. If the electronic light sources are modulated in a synchronized way at even higher speed, an image can be displayed. For example, the electronic light sources may be rotated at a speed for an image repetition or refreshment of 60 Hz and modulated at a speed of 1 MHz. A camera can then be located behind the electronic light sources that allows a video conference participant to establish eye contact by looking through the front of the terminal to the camera instead of, for example, looking at a camera mounted on the top or side of the terminal.

A display substrate is used to provide a persistence of vision display. The shape or type of display substrate may vary and may be based on the geometry of the viewing area of a particular videoconferencing terminal. For example, the display substrate includes a wheel with one or more vanes (or arms) extending from a center. The wheel is configured to carry on the front of each arm a necessary array of electronic light sources to accurately display an image while the structure is rotated by an actuator (e.g., a motor that may be centrally mounted with respect to a viewing area). As indicated above, an image repetition rate of 60 Hz may be used where the image repetition rate needs to be greater than 30 Hz. Where a single arm is used on the wheel and the image needs to be repeated or refreshed at 30 Hz, the rotation speed of the arm translates to 1800 RPM. The rotation speed can be reduced proportionally to the number of arms that may be used to provide the display. An image repetition rate greater than a 100 Hz can be used to provide a higher quality display.

Any additional electronics needed to drive the electronic light sources can be mounted on the back of each arm and out of sight from a local participant. Power to drive the electronic light sources may be transferred over the shaft of the motor by a set of brushes or coaxial transformer.

According to the present disclosure, a video signal is transmitted from a source to the display substrate via a transmission link comprising a free space transmission region as will be described in further detail below.

In some embodiments, the transmission link is an optical link comprising an optical propagation region.

In some alternative embodiments, the transmission link is a wireless link. In some specific embodiment the wireless link may be a radio link. In some other specific embodiments, the wireless link may be established by a capacitive link.

The display substrate can provide images of a remotely located videoconference participant while a camera (e.g., a video camera) mounted behind the spinning wheel captures images of a local videoconference participant through the open areas in the spinning wheel. By having the camera located behind the display substrate and looking therethrough, both videoconference participants can establish eye contact and enhance the feeling of intimacy in the communication.

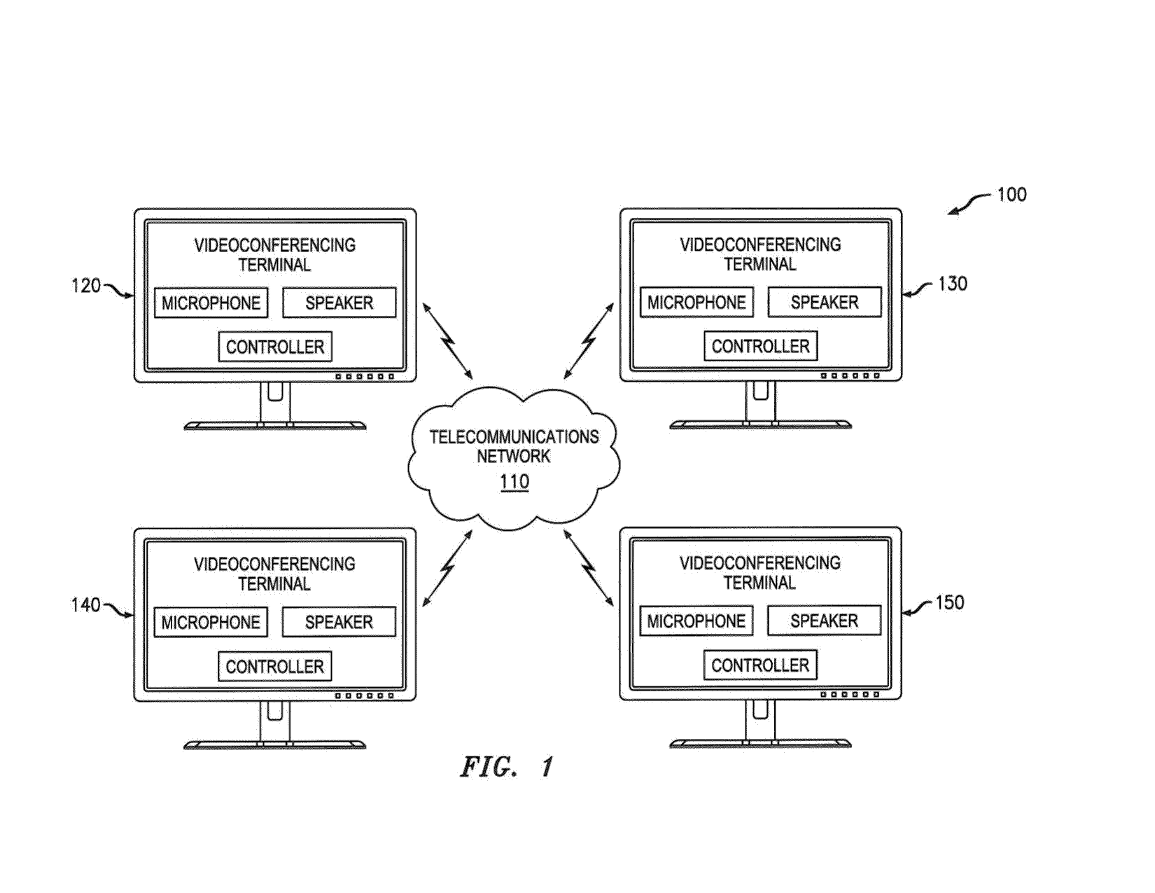

FIG. 1 is a schematic block diagram of one example of a videoconferencing infrastructure within which a videoconferencing terminal constructed according to the principles of the disclosure may operate. This embodiment of the videoconferencing infrastructure 100 is centered about a telecommunications network 110 that is employed to interconnect two or more videoconferencing terminals 120, 130, 140, 150, for communication of video signals or information, and perhaps also audio signals or information, therebetween. An alternative embodiment of the videoconferencing infrastructure 100 is centered about a computer network, such as the Internet. Still another embodiment of the videoconferencing infrastructure 100 involves a connection between two or more videoconferencing terminals, e.g., connection of the videoconferencing terminals 120, 130, via a plain old telephone (POTS) network. As represented in the videoconferencing terminal 120, the videoconferencing terminals 120, 130, 140, 150, may include components typically included in a conventional videoconferencing terminal, such as, a microphone, a speaker and a controller. The microphone can be configured to generate an audio signal based on acoustic energy received thereby, and the speaker can be configured to generate acoustic energy based on an audio signal received thereby.

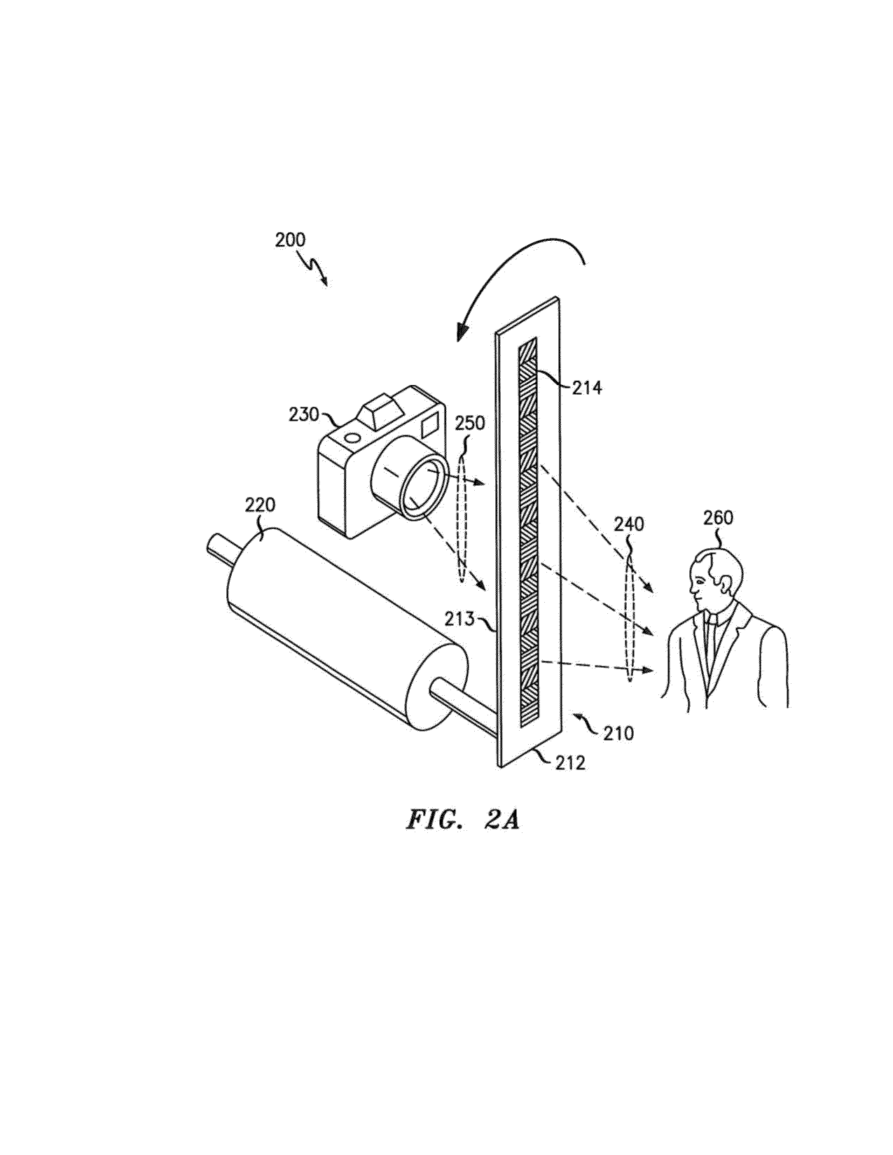

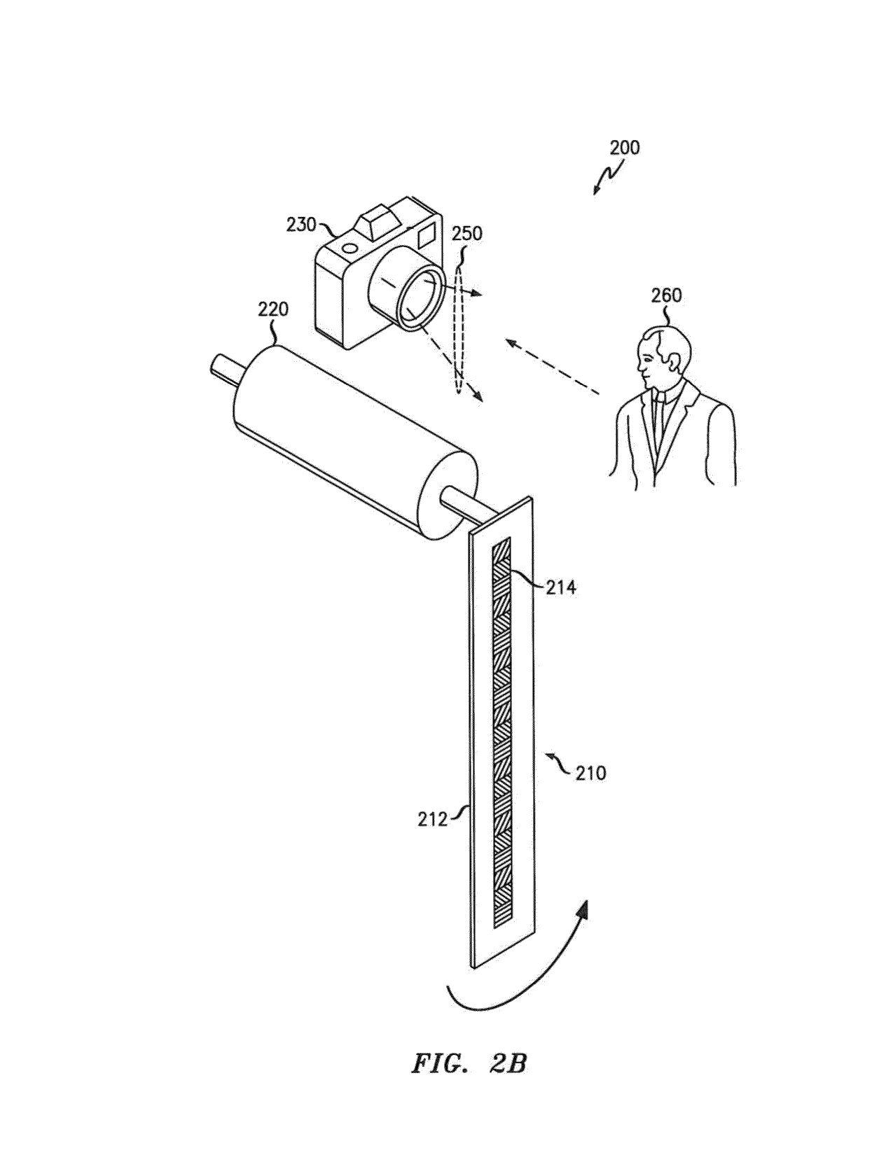

FIG. 2A and FIG. 2B are schematic views of an embodiment of a videoconferencing terminal 200, which may be used in the videoconferencing infrastructure of FIG. 1, constructed according to the principles of the disclosure. The videoconferencing terminal 200 is configured to simultaneously capture a camera image from and provide a display image to a local videoconferencing participant 260. The videoconferencing terminal 200 includes a display substrate 210, an actuator 220 and a camera 230. Additionally, the videoconferencing terminal 200 may include additional components typically included in a conventional videoconferencing terminal. For example, the videoconferencing terminal 200 may include a microphone, a speaker and a controller that directs the operation of the videoconferencing terminal 200. The microphone and speaker may be associated with the controller.

The display substrate 210 includes a substrate 212 having an array of electronic light sources 214 located thereon. The array 214 may be a single column array as illustrated or may include multiple columns. By controllably moving (e.g., rotating in this instance) the array of electronic light sources 214 over a viewing area 240, a persistence of vision display on the viewing area 240 is achieved. To that end, the number of rows of the array of electronic light sources 214 may be selected such that in operation an image generated by the electronic light sources substantially covers the viewing area 240. The viewing area 240 may coincide with a substantially transparent substrate that is placed on the viewing side of the videoconferencing terminal 200 (i.e., opposite side of the display substrate 210 from the camera 230). The display substrate 210 occupies less than an entirety of the viewing area 240. Thus, the display substrate 210 is smaller than the viewing area 240. Accordingly, persistence of vision is relied on to provide a display image for the videoconferencing terminal 200.

The display substrate may be caused to move (e.g. rotate) using of an actuator 220. In the illustrative example of FIG. 2A and FIG. 2B the actuator 220 is located behind the display substrate 210 with an axis of rotation thereof being aligned with a center point around which the display substrate 210 rotates. However this is only exemplary and the actuator may be located at other locations, i.e. off-centered with respect to the center of rotation of the display substrate 210 and the motion may be transferred to the display substrate by other facilities, such as for example a spinning arm joining the rotational axis of the actuator to a coupling mechanism located behind (on the surface opposite to the viewing surface of) the display substrate 210; or by way of a belt driven mechanism transferring the rotational movement of the axis of the actuator to the center of rotation of the display substrate 210 located behind the latter.

The videoconferencing terminal 200 also includes electronic circuitry 213 coupled to the array of electronic light sources 214. The electronic circuitry 213 is configured to control the array of electronic light sources 214 to form a display image. The electronic circuitry 213 may be located behind the display substrate, i.e. on an opposing surface of the substrate 212 from the array of electronic light sources 214 as illustrated in FIG. 2A.

The electronic circuitry 213 is configured to direct the operation of each of the electronic light sources of the array 214. The electronic circuitry 213 may be partially or totally incorporated in the substrate 212. In other embodiments, the electronic circuitry 213 for the electronic light sources 214 may be formed on a separate substrate from the substrate 212. The electronic circuitry 213 may include a matrix of thin film transistors (TFT) with each TFT driving and/or controlling a particular electronic light source of the array 214. The electronic circuitry 213 may include components typically employed in a conventional array-type active backplane. In one embodiment, the electronic circuitry 213 may operate similar to an active backplane employed in a conventional LED display. However other known display elements may likewise be used. Power to drive the electronic light sources 214 (and the electronic circuitry 213) may be transferred over a shaft of the actuator by a set of mechanical brushes. Additionally, power to drive the electronic circuitry 213, the electronic light sources 214 or other electronics associated therewith can also be transferred to the substrate 212 through magnetic induction, for example in the form of a coaxial transformer. In addition, the power transfer function may be shared or combined with the actuator function by reusing coils located on the display substrate 210 or inside the actuator 220.

According to the present disclosure, a signal containing display data for generating the display image is transmitted to the display substrate 210 from a transmitter (as described further below), propagating through a transmission link. At least a portion of the transmission link may be free space transmission region, as described further below. The free space transmission region allows for avoiding physical contact between at least some of the movable and non-movable parts involved in the propagation path of the signal from the transmitter to a receiver.

In some embodiments the transmission is optical transmission. In such embodiments, an optical transmitter, and optical link comprising an optical propagation region and an optical receiver are used, wherein at least a portion of the optical link comprises a free space optical transmission region.

In some alternative embodiments the transmission is radio (wireless) transmission. In such cases, a radio transmitter, a radio link and a radio receiver are used, wherein at least a portion of the radio link comprises a free space transmission region.

The signal containing display data is received by the receiver (either optical or radio). The display data contains activation commands for the electronic light sources 214. The received signal is then converted by means of a suitable converter (not shown) into electrical signal which is usable by the electronic circuitry 213 in order to drive the electronic light sources of the array 214. A converter for optical to electronic conversion may be for example a PIN diode or an Avalanche Photodiode. For radio transmission a known antenna may be used for such conversion.

Once the signals received are converted into electric signals, the latter may be provided to the electronic circuitry 213 to provide the display image. The electronic circuitry 213 may then employ the received signals to control the array of electronic light sources 214 so as to distribute between the electronic light sources 24 corresponding activation commands in order to display the display image in the viewing area 240. The task of distributing the activation commands may be performed by a known device such as for example a field-programmable gate array (FPGA).

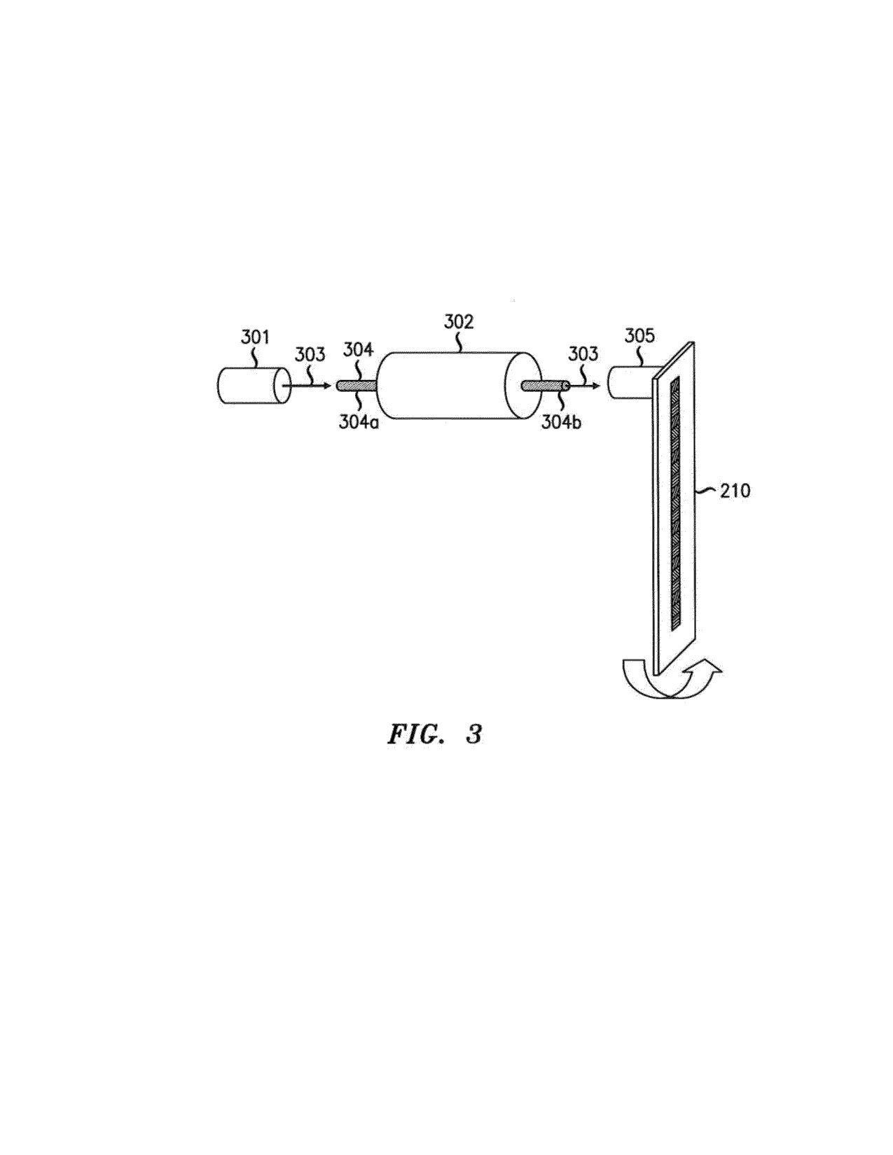

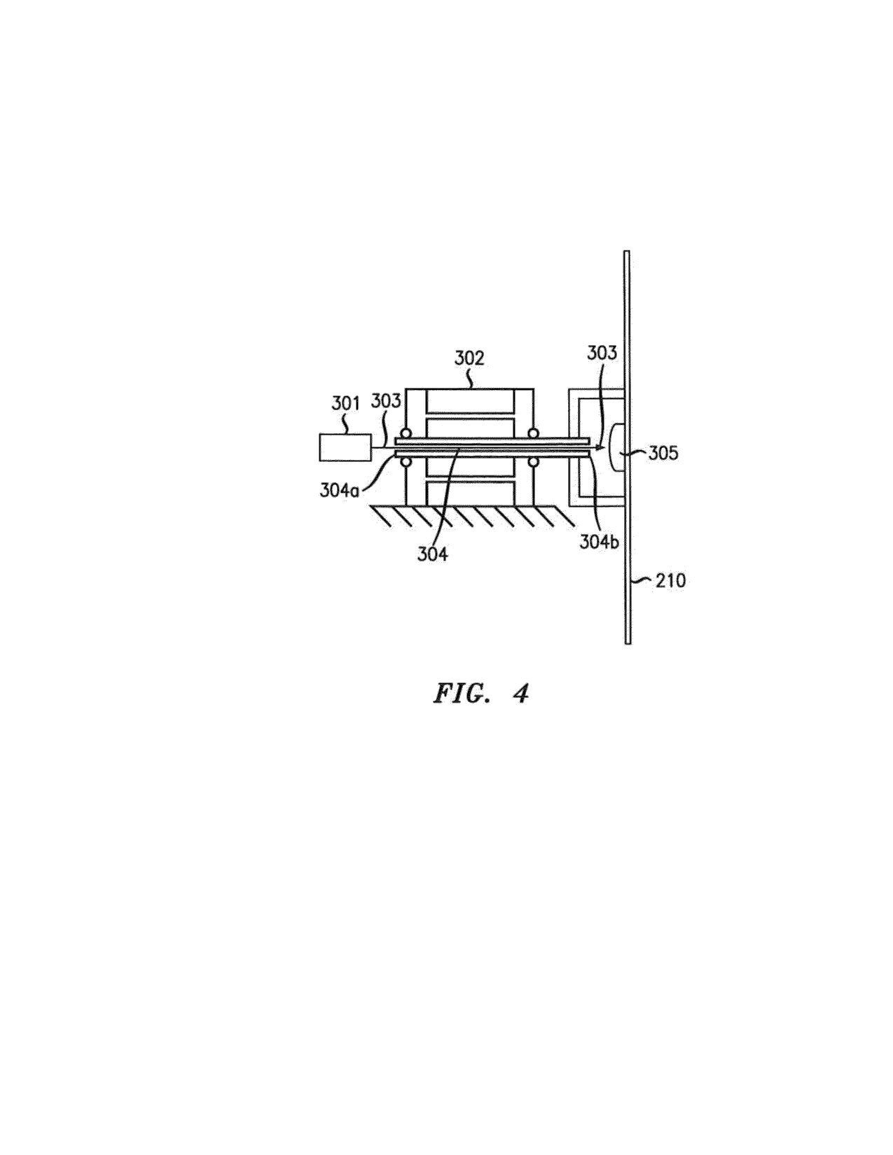

Referring now to FIG. 3 and FIG. 4, certain elements of a videoconferencing terminal are described according to one embodiment in which optical transmission is used. In this embodiment an optical signal 303 containing data related to videoconferencing is generated using an optical transmitter 301. For example, the optical transmitter 301 is a modulated light source.

The optical signal 303 generated by the optical transmitter 301 propagates through an optical link and is input into an optical receiver 305, such as an optical detector. The optical receiver 305 is in turn coupled to the display substrate 210. For example, the optical receiver 305 may be positioned on the rear side (the side opposite the visualization side of the display substrate) as shown in FIG. 3 and FIG. 4.

As shown in the illustrative embodiment of FIG. 3 and FIG. 4, an optical propagation region 304 is present between the optical transmitter 301 and the optical receiver 305. In this configuration the optical transmitter 301 may be positioned optically aligned and physically proximate to, but at a certain separation from, an input port 304a of the optical propagation region 304 such that an optical signal 303 generated by the optical transmitter 301 may be coupled into the input port 304a of the optical propagation region 304, as shown in FIG. 3 and FIG. 4. The optical propagation region 304 is configured to allow the optical signal 303 generated by the optical transmitter 301 to propagate therethrough and to output said optical signal 303 at an output port 304b thereof.

The separation between the optical transmitter 301 and the input port 304a of the optical propagation region 304 may comprise a free space optical transmission region.

The output port 304b of the optical propagation region 304 is in turn optically aligned with an input port (not shown) of the optical receiver 305 as shown in FIG. 3.

In some embodiments, the display substrate—with the optical receiver 305 mounted thereon—may be directly driven by a rotating shaft of the actuator (as shown in FIG. 4). This may be possible for example in the configuration shown in FIG. 3 and FIG. 4 where the axis of rotation of the actuator 302 is geometrically aligned, and a propagation axis of the optical propagation region 304 is optically aligned with the input port of the optical receiver 305. Such direct drive configuration may be achieved by known techniques, for example by using connecting arms between the actuator 302 and the optical receiver 305 (not shown).

In some alternative embodiments, the display substrate—with the optical receiver 305 mounted thereon—may not be directly driven by the rotating shaft of the actuator. This may occur for example in a configuration in which the axis of rotation of the actuator 302 is not geometrically aligned, and a propagation axis of the optical propagation region 304 is not optically aligned with the input port of the optical receiver (i.e. an off-center configuration as discussed above). In such circumstances, the rotation of the shaft of the actuator may be transferred to the display substrate by mechanical devices such as belts or connecting rods.

In some embodiments, the output port of the optical transmitter 301 may not be optically aligned with the input port of the optical receiver 305. This may be case for example where the optical transmitter 301 is located at an arbitrary unaligned position, for example at a higher, lower or lateral offset level, with respect to the position of the optical receiver 305. In such cases, the optical signal transmitted from the optical transmitter 301 may propagate through the optical propagation region 304, which in this case may be for example an optical fiber providing an optical waveguide functionality, until the optical signal reaches the optical receiver 305.

However, in the embodiments where the optical transmitter 301 and the optical receiver 305 are not optically aligned (i.e. where the optical signal is conveyed through the optical propagation region using a guiding material such as an optical fiber), the optical alignment between the optical transmitter 301 and the input port 304a of the optical propagation region 304 and the optical alignment between the output port 304b of the optical propagation region 304 and the optical receiver 305 is preferably maintained.

The optical propagation region 304 may be provided by any known techniques allowing the propagation of light. Some non-limiting examples of the optical propagation region may be optical fiber, air or a vacuum.

In case the optical propagation region 304 is air or a vacuum, then the optical transmitter 301 and the optical receiver 305 are preferably directly optically aligned. In such cases, the input port 304a and the output port 304b of the optical propagation region 304 are to be understood to respectively refer to a free space entrance end (where the optical signal is input) and a free space exit end (where the optical signal is output) of the optical propagation region 304.

Turning back to the embodiment of FIG. 3 and FIG. 4, the actuator 302 (similar to the actuator 220 of FIG. 2A or FIG. 2B) may be positioned such that an axis of rotation caused by the actuator coincides with the optical propagation region 304, as shown. In this manner, the videoconferencing data contained in the optical signal 303 may propagate through the optical propagation region 304 which is within the actuator and be output from the output port 304b thereof toward the optical receiver 305.xxx

Preferably the output port 304b of the optical propagation region 304 and the input port of the optical receiver 305 are positioned optically aligned and physically proximate to, but at a certain separation from each other such that the optical signal 303 output from the output port 304b of the optical propagation region 304 is coupled into the optical receiver 305, as shown in FIG. 3 and FIG. 4.

The separation between the output port 304b of the optical propagation region 304 and the input port of the optical receiver 305 may comprise a free space optical transmission region.

The optical transmitter 301 may be an XFP optical Gigabit Ethernet transmitter capable of sending digital data over an optical fiber. The optical fiber (if used) may be a multimode optical fiber. Use of a multimode fiber may be advantageous because it may simplify the alignment of the optical signal with the optical transmitter at an input, or with the optical receiver at an output thereof. The optical receiver may be an XFP Gigabit Ethernet optical receiver.

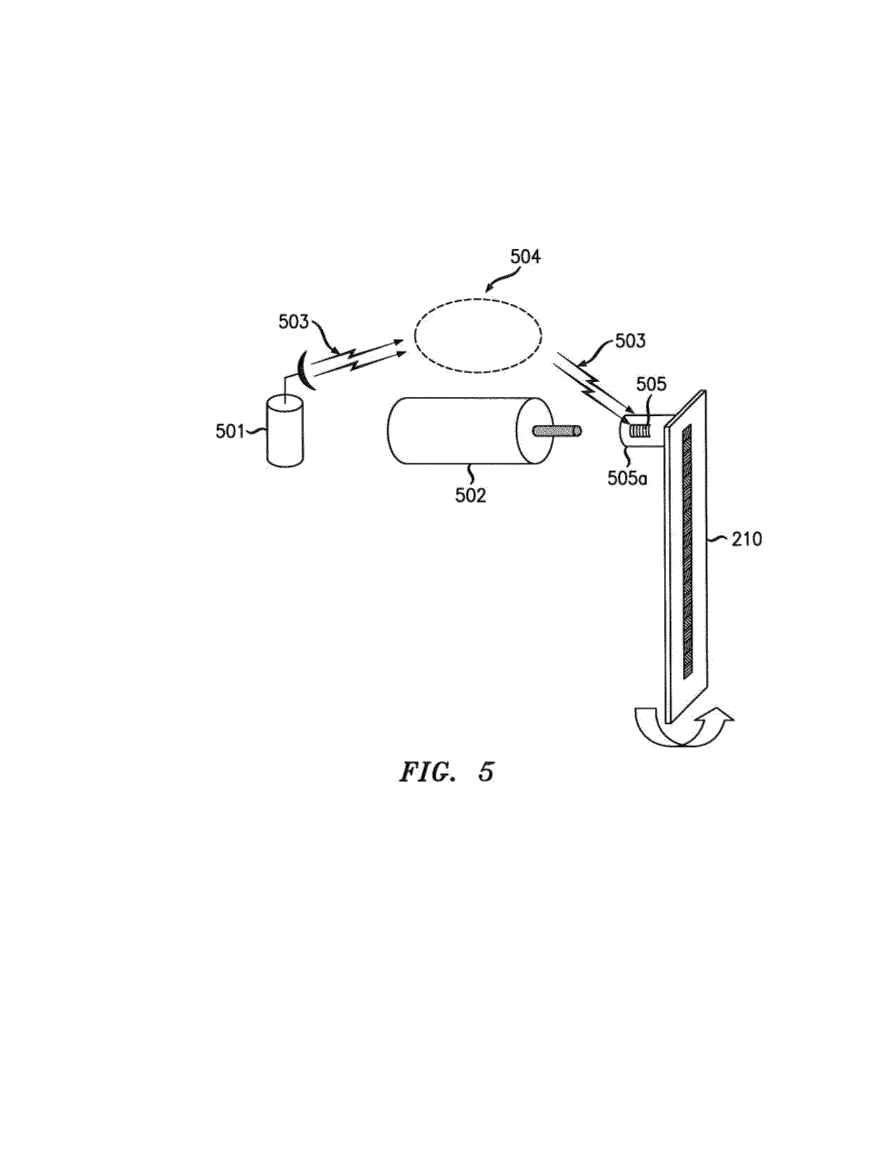

Referring now to FIG. 5, certain elements of a videoconferencing terminal are described according to another embodiment in which radio transmission is used. In this embodiment a radio signal 503 (such as a video signal) containing data related to videoconferencing is generated by means of a radio transmitter 501. Preferably the radio transmitter 501 generates a modulated radio signal.

The radio signal 503 generated by the radio transmitter 501 propagates through a radio link, schematically shown by reference numeral 504 and is input into a radio receiver 505. The radio receiver 505 may be positioned on a support structure 505a which is in turn coupled to the display substrate 210. Preferably the radio receiver 505 is positioned on the rear side (the side opposite the visualization side of the display substrate) as shown in FIG. 5.

In the embodiments where radio transmission is used, it is immaterial whether or not the radio transmitter 501 is physically aligned with the radio receiver. As long as the signal transmitted from the radio transmitter 501 is capable of reaching the radio receiver 505, the conditions for transmission are in principle satisfied.

In these embodiments, the radio link 504 may be considered as a free space transmission region.

Similar considerations as regards the various possible configurations between the actuator and the display substrate (e.g. aligned, off-centered and the related mechanisms to transfer movement from the actuator to the display substrate) as described with respect to the embodiments of FIG. 3 and FIG. 4 are by analogy also applicable to the embodiments of FIG. 5.

Therefore, the provision of a link to transport (either optically or wirelessly) the visualization data from the transmitter to the receiver wherein at least a portion of the link comprises a free space transmission region, provides an efficient manner of conveying the visualization data to the electronic light sources 214 without a need to provide physical contact between said elements for enabling data transmission (as would be the case in electronic transmission).

This configuration has important advantages. Indeed, if one was to consider the use of electronic communication of the visualization data from an electronically operated transmitter to an electronically operated receiver, such transmission would require physical contact between electrically conductive media (such as wires) capable of conducting electrical signals between rotating and static mechanisms (for example by using metallic brushes). However after some amount of usage, such conductive media would inevitably wear out due to friction present between the moving and non-moving parts thereby causing degradation or even loss of communication, and requiring maintenance. In contrast, the videoconferencing configuration based on the use of a link comprising a free space transmission region as proposed herein would not suffer from such drawbacks as physical contact is not required (at least in a portion of the optical link) for ensuring the coupling of the videoconferencing data to the display substrate.

Another significant advantage of the solution proposed herein is the possibility to enhance the data throughput in videoconferencing transmission. This advantage may become particularly significant in cases where an optical link is used. As it is known, an optical link is typically capable of allowing higher transmission rates as compared to metallic wires. With the configuration proposed herein it may be possible to reach data transmission rates in the gigabit range (e.g. 1.25 Gbit/s or higher).

Although the embodiments related to the use of optical transmission have been described separately from the embodiments related to the use of radio transmission, it is to be noted that a combination of the two alternative embodiments may also be used in a videoconferencing terminal according to the principles of the present disclosure. One useful implementation of such possibility is the provision of a terminal comprising both optical and radio transmission capabilities where under certain conditions the terminal may operate under one of the two transmission modes and in case of a failure of the transmission mode, the terminal may be switched to operate under the other (alternative) transmission mode.

A further possibility of constructing a wireless link may be envisaged by the use of a capacitive link. In such embodiment two conductor bodies (e.g. capacitor plates), one stationary and one rotating in close proximity to each other may be used such that a voltage change on one conductor body may induce a current in the other conductor body. The conductor bodies may for example have a round flat shape positioned opposite to each other on the actuator axis.

The camera 230 is configured to capture a camera image. The camera 230 has a field of view 250 that at least partially overlaps the viewing area 240 and is configured to capture the camera image through the viewing area 240. The camera 230 may be of the type and have the functionalities as disclosed in the above-referenced US 2011/0149012.

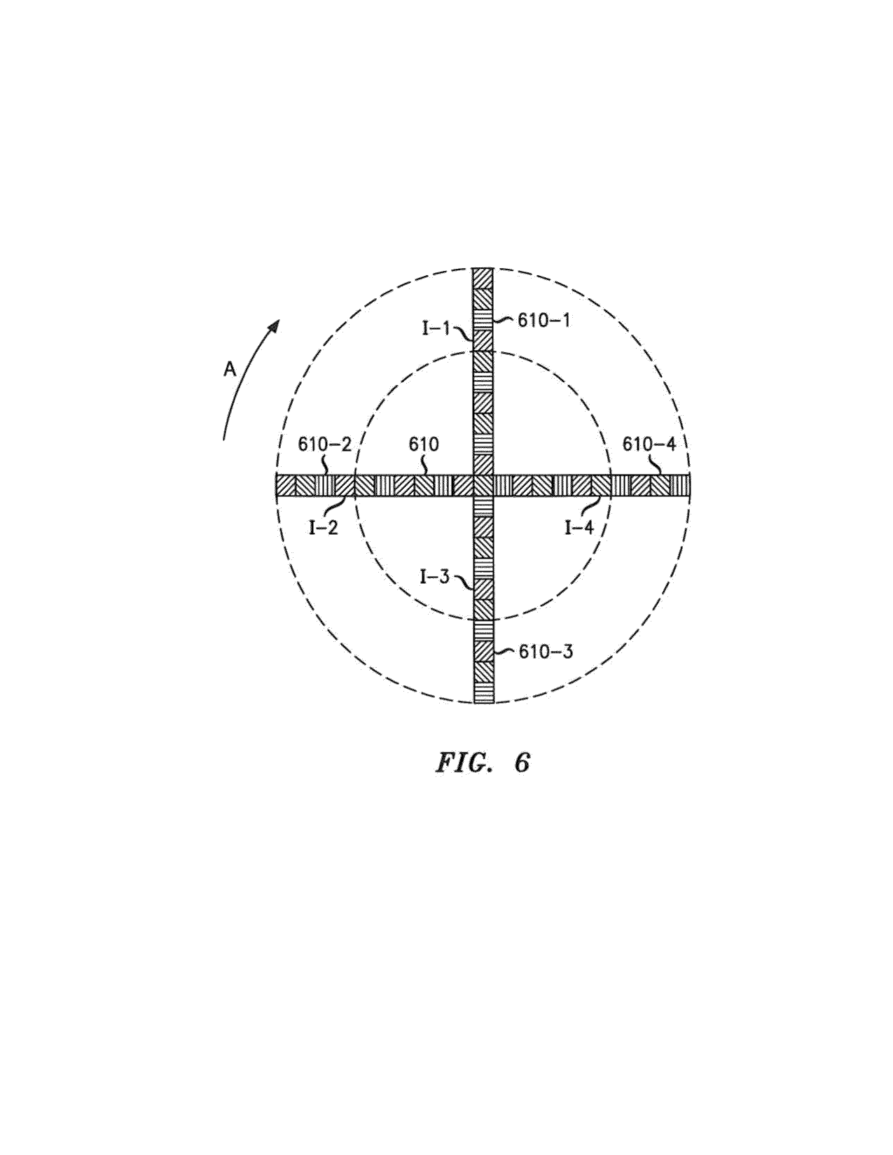

FIG. 6 is an exemplary representation of an alternative embodiment of a display substrate according to the principles of the disclosure. In this embodiment, the display substrate 610 has multiple arms 610-1, 610-2, 610-3 and 610-4. Each of the multiple arms of the display substrate 610 may be moved by an actuator such as the actuator 220 of FIGS. 2A, 2b, 3 and 4. As with the display substrate 210, the display substrate 610 may also be rotated by the actuator 220 to provide a display image in a circular coverage area. As such, the individual light of the electronic light sources of the display substrate 610 have concentric trajectories (indicated by dashed lines) that provide the display image over a circular coverage area.

The embodiment of FIG. 6 may be used to allow for enhanced image repetition. For example a specific image may be repeated over two (or more) subsequent arms as one arm occupies, after a certain angular rotation, a position previously occupied by the previous arm. For a better understanding of this feature, it may be assumed that at instant t1 during the rotation of the arms 610-1, 610-2, 610-3 and 610-4, arm 610-1 displays a combination of activated and non-activated pixels thereby constructing image I-1, arm 610-2 displays a combination of activated and non-activated pixels thereby constructing image I-2, arm 610-3 displays a combination of activated and non-activated pixels thereby constructing image I-3, and arm 610-4 displays a combination of activated and non-activated pixels thereby constructing image I-4. At instant t2, after a predetermined angular rotation, for example 90°, arm 610-2 which now occupies the position previously occupied by arm 610-1 would display image I-1 (i.e. same image previously displayed by arm 610-1). Likewise, arm 610-3 which now occupies the position previously occupied by arm 610-2 would display image I-2, arm 610-4 which now occupies the position previously occupied by arm 610-3 would display image I-3 and arm 610-1 which now occupies the position previously occupied by arm 610-4 would display image I-4.

The above image repetition feature may be provided using more than two arms to repeat the same image as the arms rotate according to the specific requirements of a particular implementation.

This configuration has the advantage of enhancing the effect of persistence of vision because of the longer lasting presence of the image in front of the person watching such image thereby viewing an image of higher quality.

Alternatively, instead of repeating the images I-1, I-2, I-3 and I-4 as described above to enhance the quality of the image, a higher transmission rate may become available because instead of displaying the images I-1, I-2, I-3 and I-4 one after the other at four different instants during the rotation of a single arm display substrate, images I-1, I-2, I-3 and I-4 may be shown simultaneously at the same instant t1 and images I′-1, I′-2, I′-3 and I′-4 may be shown simultaneously at the same instant t2, thereby enabling a faster rate of data transmission to the electronic light sources 214 (e.g. Pixels).

Herein, terms such as spinning and rotating of the display substrate have been used interchangeably which refer to a circular sweeping movement of the display substrate in the space thus defining a circular surface. However, the disclosure is not to be understood as being limited to only such type of motion and other types of motion of the display substrate may fall within the scope of the claimed invention. One example of such alternative motion is one causing the display substrate to cover a substantially rectangular viewing area such as the embodiment depicted in FIG. 5B of the above-referenced US 2011/0149012.

It may occur in occasions that during operation, the display substrate may produce some level of noise or suffer from vibration as it is being rotated, or otherwise moved. Also the high speed rotation of the display substrate may produce some friction against the ambient air (air drag). These phenomena may be undesirable and the air drag may further cause an increase in power consumption.

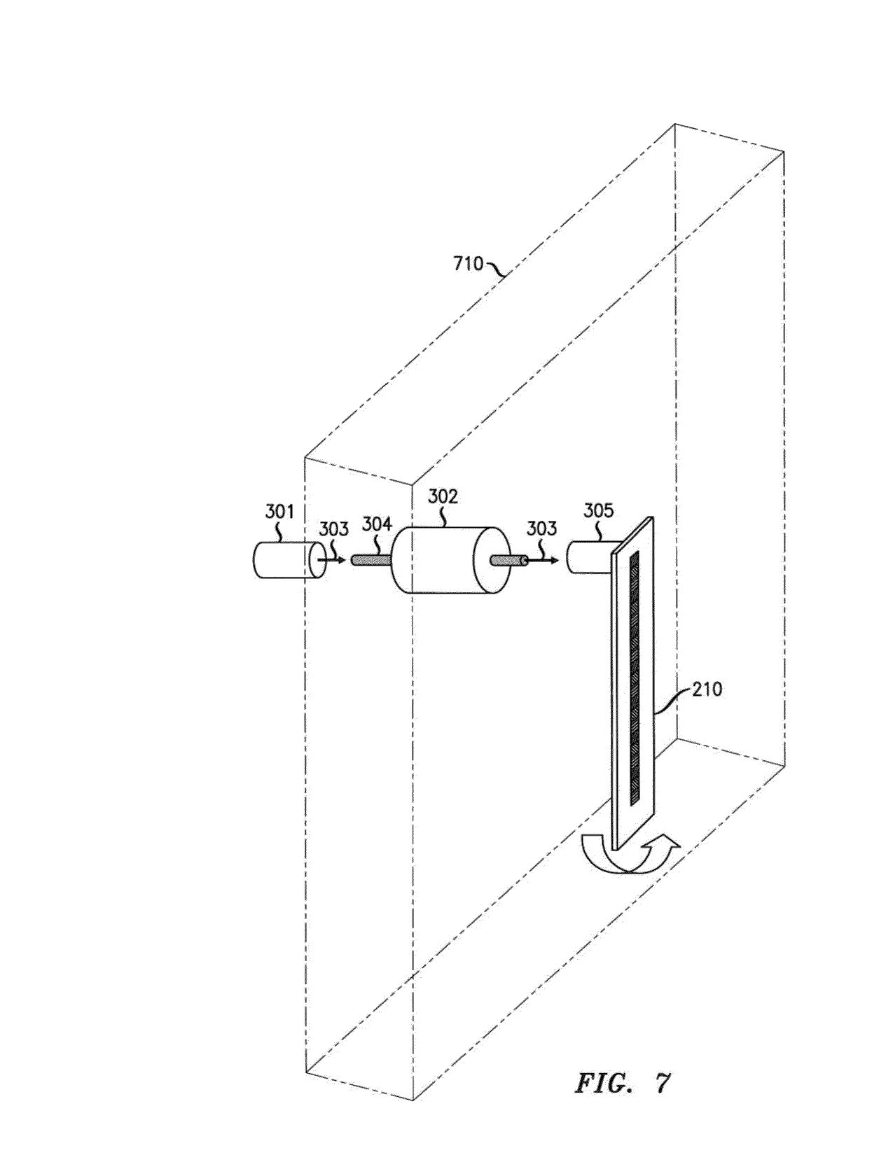

As one solution, the display substrate may be made with aerodynamic shape which, at least to some extent, may help reduce the above undesired effects. Further remedies for avoiding or at least reducing the above effects may be obtained by using the solution provided in relation to an alternative embodiment as provided in relation with FIG. 7.

In FIG. 7, unless otherwise indicated, like elements have been given like reference numerals as those of FIG. 3 and FIG. 4. It is to be noted that although, for the sake of briefness, the embodiment of FIG. 7 refers to similar elements as those of FIG. 3 and FIG. 4 which relate to embodiments in which optical transmission is used, the embodiment of FIG. 7 is not to be understood as being limited to optical transmission of the videoconferencing data and that the same may be likewise applicable to embodiments in which radio transmission is employed as the embodiment of FIG. 5.

The embodiment of FIG. 7 is similar to the embodiment shown in FIG. 3 and FIG. 4 with the difference that in the embodiment of FIG. 7, at least the display substrate 210 is located and is movable inside a housing 701. The housing may be transparent at least on the side where the image is to be visualized and made such that it would not block the visual contact between the videoconference participant and the camera.

In order to reduce noise, power consumption and air drag as described above, the housing may be provided with an inside pressure which is less than the atmospheric pressure in the ambient. Preferably in order to provide such reduced inside pressure, the housing 710 is hermetically sealed in order to avoid exchange of the air pressure with the surroundings.

In some embodiments, the sealed housing 710 may comprise an inside pressure substantially lower than the ambient pressure, for example a fraction of the atmospheric pressure. In some embodiments the housing 710 may substantially comprise vacuum inside. With the reduced pressure, or vacuum, provided inside the housing the noise, the power consumption and the air drag, caused by the rotation of the display substrate 210 may be greatly reduced.

Preferably, the actuator 302 that drives the display substrate 210 is decoupled from the housing 710 in order to reduce transmission of vibration to the housing.

Further measures related to the reduction of the above undesired effects may also be taken. For example the display substrate arm(s) may be made in aerodynamic shape, in particular at the edges thereof. Also, the actuator 302 may be held in place using a number of rubber feet to further reduce vibration.

A variety of options for providing elements of the videoconferencing terminal inside the housing may be envisaged.

In one embodiment the transmitter 301 (or 501), the transmission link 304 (or 504) and the receiver 305 (or 505) are located inside the housing 710 (also with the display substrate 210 therein). In such case, the data may be supplied to the transmitter from outside the housing by means of an electrical or optical feed-through connection (passing through a wall of the housing in an air-tight, or vacuum-tight manner).

In another embodiment, the transmitter 301, or the transmitter and the transmission link 304 (or 504), may be located outside the housing 710 (with the receiver 305 (or 505) and the display substrate 210 located inside the housing). In such cases and where optical transmission is employed, use may be made of a coupling window (e.g. a transparent window on a wall of the housing being made of a solid material, e.g. glass) located on the optical coupling path from the optical transmitter 301, or from the optical transmitter 301 and the optical propagation region 304, to the interior space of the housing and further to the optical receiver 305.

Other known methods of conveying the display data from outside the sealed housing to inside thereof, while maintaining the hermetic condition of housing, may likewise be used.

In some embodiments, it may be desirable to provide feedback information from the display substrate to other elements of the terminal, or to a control center. For example it may be desirable to control the temperature variation caused on the display substrate or on circuitry coupled to the display substrate, as it moves in order to avoid overheating. This feedback information may be used by a control unit which may be located at a convenient location in the terminal in order to take measures and/or generate commands in order to adjust the operation of the terminal so that such overheating is avoided or remedied. Other types of feedback information may also be desirable.

In order to provide such feedback information, the transmission link may be made bi-directional and respective transmitters and receivers may be installed at both sides of the transmission link, with at least one free space transmission region being present on the transmission link between the transmitters and the receivers.

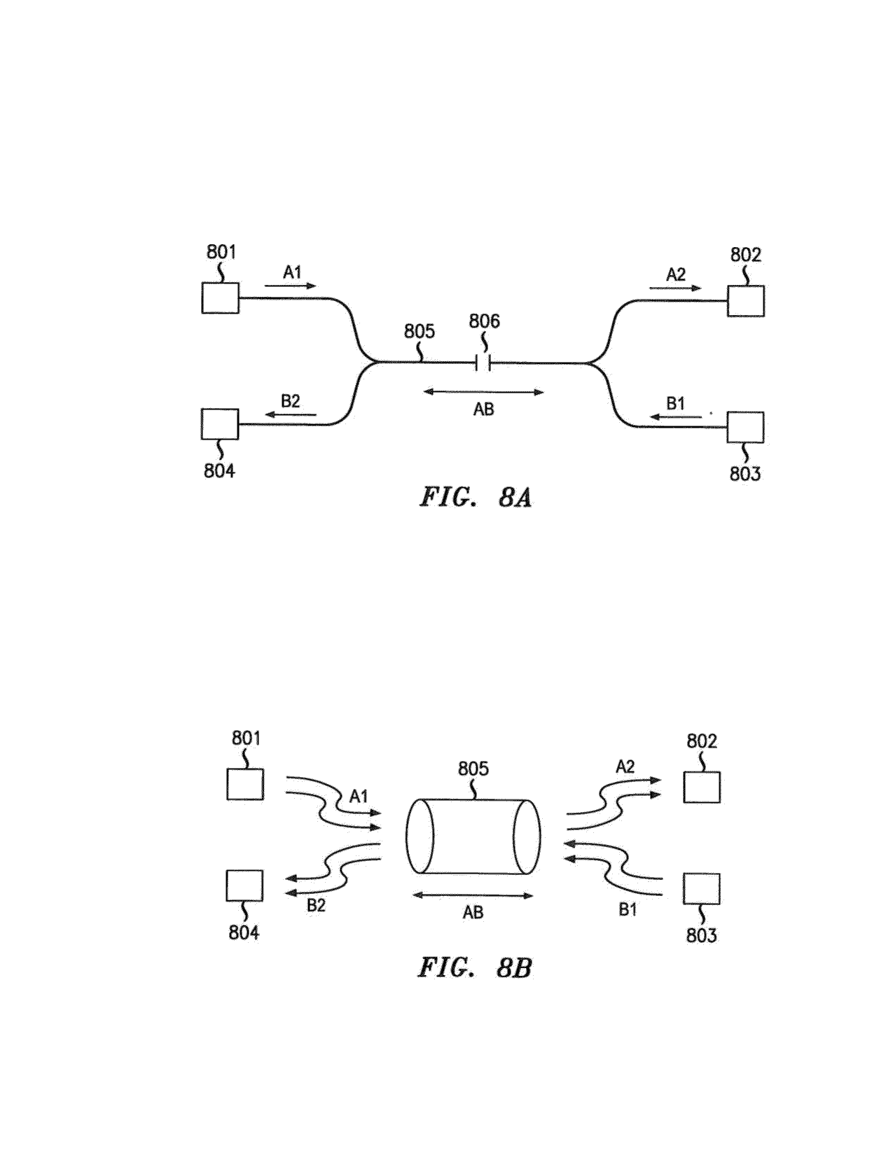

FIG. 8a depicts a simplified exemplary representation of such configuration in which an optical link is employed. In FIG. 8a a first optical transmitter 801 may transmit videoconferencing data received from a remote videoconferencing terminal, in a first transmission direction A1-AB-A2 to a first optical receiver 802 coupled to the display substrate (not shown). In this first transmission direction, at least part of the transmission takes place through the optical propagation region 805. The optical propagation region 805 has at least one free space optical transmission region 806.

In addition, a second optical transmitter 803, coupled to the display substrate, may transmit feedback information in a second transmission direction (or a feedback direction) B1-AB-B2 to a second optical receiver 804 coupled to a control unit (not shown). In this second transmission direction, at least part of the transmission takes place through the optical propagation region 805, which as mentioned before, has at least one free space optical transmission region 806.

FIG. 8b depicts a simplified exemplary representation of such configuration in which radio link is employed. In FIG. 8b a first radio transmitter 801 may transmit videoconferencing data received from a remote videoconferencing terminal, in a first transmission direction A1-AB-A2 to a first radio receiver 802 coupled to the display substrate (not shown). In this first transmission direction, at least part of the transmission takes place through the radio link 805 which clearly comprises at free space transmission region.

In addition, a second radio transmitter 803, coupled to the display substrate, may transmit feedback information in a second transmission direction (or a feedback direction) B1-AB-B2 to a second radio receiver 804 coupled to a control unit (not shown). In this second transmission direction, at least part of the transmission takes place through the radio link 805, which as mentioned before, comprise free space transmission region.

Those skilled in the art to which the application relates will appreciate that other and further additions, deletions, substitutions and modifications may be made to the described embodiments. Additional embodiments may include other specific terminal. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

What is claimed is:

1. An apparatus, comprising:
a display substrate having a plurality of light sources thereon; and
a receiver jointly movable with the display substrate relative to a transmitter, the receiver being configured to receive a signal containing information from the transmitter through a transmission medium comprising free space, the information being usable for selectively activating the light sources to generate an image.

2. The apparatus of claim 1, wherein the display substrate occupies less than an entirety of a viewing area, the apparatus further comprising:
an actuator configured to move the display substrate over the viewing area;
a camera having a field of view at least partially overlapping the viewing area and configured to capture a camera image through the viewing area.

3. The apparatus of claim 1, wherein the transmitter is an optical transmitter configured to transmit an optical signal, the transmission medium comprises an optical transmission link comprising an optical propagation region configured to allow propagation of the optical signal, and the receiver is an optical receiver configured to receive the optical signal from the optical transmission link, wherein at least a portion of the optical transmission link comprises a free space optical transmission region.

4. The apparatus of claim 1, wherein the transmitter is a radio transmitter configured to transmit a radio signal, the transmission medium comprises a radio transmission link configured to allow propagation of the radio signal, and the receiver is a radio receiver configured to receive the radio signal from the radio transmission link, wherein the radio transmission link comprises a free space transmission region.

5. The apparatus of claim 1, comprising an optical transmitter configured to transmit an optical signal, a radio transmitter configured to transmit a radio signal, an optical receiver configured to receive the optical signal, a radio receiver configured to receive the radio signal.

6. The apparatus of claim 3, wherein the optical transmitter is a modulated light source.

7. The apparatus of claim 3, wherein the optical transmitter is positioned optically aligned to, and at a certain separation from, an input port of the optical propagation region.

8. The apparatus of claim 7, wherein the separation between the optical transmitter and the input port of the optical propagation region comprises a free space optical transmission region.

9. The apparatus of claim 3, wherein an axis of rotation of the actuator is geometrically aligned, and a propagation axis of the optical propagation region is optically aligned with an input port of the optical receiver.

10. The apparatus of claim 3, wherein the optical propagation region is an optical fiber, air or vacuum.

11. The apparatus of claim 3, wherein the optical transmitter and an input port of the optical propagation region are optically aligned; and an output port of the optical propagation region and the optical receiver are optically aligned.

12. The apparatus of claim 3, wherein an output port of the optical propagation region is positioned optically aligned, and at a certain separation from, an input port of the optical receiver.

13. The apparatus of claim 12, wherein the separation between the optical transmitter and the input port of the optical propagation region comprises a free space optical transmission region.

14. The apparatus of claim 1, wherein the display substrate comprises a plurality of arms configured for displaying an image over a first arm located at a first position at a first instance and displaying said image on a second arm at said first position at a second instance subsequent to the first instance.

15. The apparatus of claim 1, wherein the display substrate is movably located inside a housing having an inside pressure lower than the atmospheric pressure.

16. The apparatus of claim 15, wherein the housing is hermetically sealed comprising an inside pressure of a fraction of the atmospheric pressure.

17. The apparatus of claim 15, wherein inside the housing is substantially vacuum.

18. The apparatus of claim 15, wherein one or more display substrate arms may have aerodynamic shape.

19. The apparatus of claim 1, wherein the transmission medium is bi-directional and the apparatus comprises a transmitter coupled to the display substrate and configured to transmit feedback information to at least one other element of the apparatus.
